(19) United States
(12) Patent Application Publication
(10) Pub. No.: US 2015/0170045 A1
(43) Pub. Date: Jun. 18, 2015

(54) EVENT ATTENDANCE PREDICTION

(71) Applicants: Stephen KIRKHAM, San Francisco, CA (US); Brandon Bilinski, San Francisco, CA (US)

(72) Inventors: Stephen KIRKHAM, San Francisco, CA (US); Brandon Bilinski, San Francisco, CA (US)

(73) Assignee: Google Inc., Mountain View, CA (US)

(21) Appl. No.: 13/402,830

(22) Filed: Feb. 22, 2012

(51) Int. Cl. G06N 5/04; G06N 7/00

(52) U.S. Cl. CPC G06N 5/048; G06N 7/005

(57) ABSTRACT

Systems and methods for predicting attendance at an event are provided. A method includes, transmitting, via the one or more computing devices, an invitation to an invitee, the invitation identifying the event. The method also includes receiving, at the one or more computing devices, invitee information related to the invitee. The method also includes receiving, at the one or more computing devices, event information related to the event. The method also includes determining an estimated probability of the invitee attending the event based on the invitee information and the event information. The method also includes providing an indication of the estimated probability of the invitee attending the event.

### FIELD

The subject technology generally relates to social networking interfaces and, in particular, relates to event attendance prediction.

### BACKGROUND

Knowing the number of people who are coming to a social event, e.g., a party or a group outing, and knowing whether a particular person is coming to the social event, may be useful in order to properly plan the event (e.g., to reserve enough tables and chairs, to prepare appropriate food, etc.). To obtain this information, hosts or organizers of social events may invite guests to the social events via Internet-based social networks or event planning services. The Internet-based social networks or event planning services typically allow the invited guests to provide electronic RSVPs to events indicting whether the invited guests will attend, will not attend, or will “maybe” attend.

### SUMMARY

The disclosed subject matter relates to a method, implemented on one or more computing devices, for predicting attendance at an event. The method includes transmitting, via the one or more computing devices, an invitation to an invitee, the invitation identifying the event. The method also includes receiving, at the one or more computing devices, invitee information related to the invitee. The method also includes receiving, at the one or more computing devices, event information related to the event, the event information being separate and distinct from the invitee information. The method also includes determining an estimated probability of the invitee attending the event based on the invitee information and the event information. The method also includes providing an indication of the estimated probability of the invitee attending the event.

The disclosed subject matter further relates to a computer-readable medium. The computer-readable medium includes instructions that, when executed by a machine, cause the machine to implement a method for predicting attendance at an event. The instructions include code for transmitting an invitation to a member of a social network, the invitation identifying the event. The instructions also include code for receiving member information related to the member. The instructions also include code for receiving event information related to the event, the event information being separate and distinct form the member information. The instructions also include code fore determining an estimated probability of the member attending the event based on the member information and the event information. The instructions also include code for providing an indication of the estimated probability of the member attending the event.

The disclosed subject matter further relates to a system. The system includes one or more processors. The system also includes a memory including instructions which, when executed by the one or more processors, cause the one or more processors to implement a method for predicting attendance at an event. The instructions include code for transmitting an invitation to a each invitee within a set of invitees, the invitation identifying the event. The instructions also include code for receiving an invitee information subset related to each invitee within a first subset of the set of invitees. The instructions also include code for receiving event information related to the event. The instructions also include code for determining an estimated number of guests attending the event based on the invitee information subset and the event information. The instructions also include code for providing an indication of the estimated number of guests.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The features of the subject technology are set forth in the appended claims. However, for purpose of explanation, several aspects of the disclosed subject matter are set forth in the following figures.

FIG. 1 illustrates an example of a computer system configured to predict event attendance.

FIG. 2 illustrates an example of the database of FIG. 1 in more detail.

FIG. 3 illustrates an example of the server of FIG. 1 in more detail.

FIG. 4 illustrates an example of the client computing device of FIG. 1 in more detail.

FIG. 5 illustrates an example of a web browser window configured to display information about an event.

FIG. 6 illustrates an example process by which an estimated probability of an invitee attending an event may be provided.

FIG. 7 illustrates an example process by which an estimated number of guests attending an event may be provided.

FIG. 8 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, conventional RSVP systems may allow invited guests to provide electronic RSVPs to events indicting whether the invited guests will attend, will not attend, or will “maybe” attend. One drawback of the conventional RSVP scheme is that RSVPs by invited guests are often unreliable. For example, an invited guest may often RSVP as attending an event, for example, to cause the event to be added to his/her calendar, and then fail to attend the event. As a result, the host, planner, or organizer of the event may have inaccurate data regarding the number and the identity of the guests at the event. As the foregoing illustrates, a more reliable technique for predicting event attendance may be desirable.

The subject technology is related to predicting attendance at an event. In one implementation, a server (e.g., a server associated with an Internet-based event planning service or social network) transmits an invitation to an invitee. The invitation may identify the event. The server may receive invitee information related to the invitee. The invitee information may include, among other things, an indication of whether and how the invitee responded to the invitation and/or data stored within a social networking profile of the invitee. The server may receive event information related to the event. The event information may be separate and distinct from the invitee information. The event information may include, among other things, a title of the event, a date and time of the event, a location of the event, an identity of a host of the event, and/or data stored within a webpage describing the event. The server may determine an estimated probability of the invitee attending the event based on the invitee information and the event information. The server may provide providing an indication of the estimated probability of the invitee attending the event. For example, the estimated probability of the invitee attending the event may be presented on a webpage describing the event in conjunction with a guest list for the event.

Advantageously, in some implementations of the subject technology, a probability that a particular user will attend an event or an estimated number of guests attending an event may be more accurately determined. As a result, hosts, planners, or organizers of the event may be able to make plans for the event based on the predicted attendance.

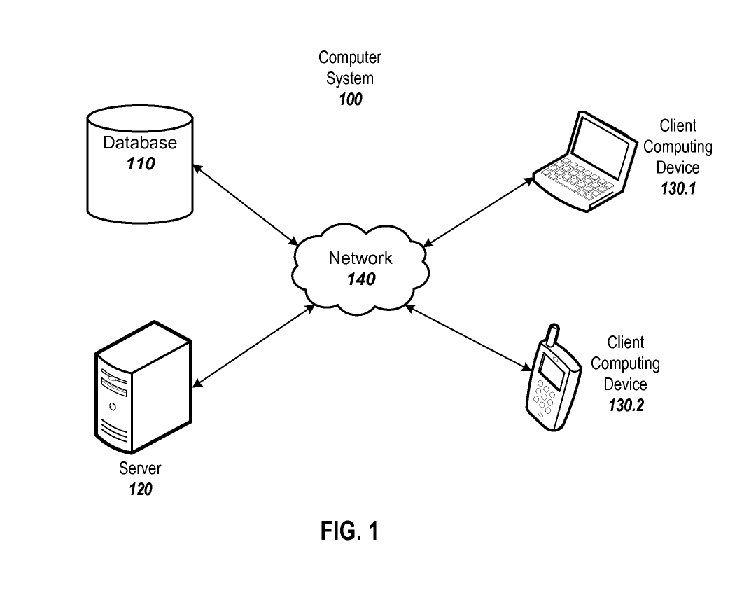

FIG. 1 illustrates an example of a computer system 100 configured to predict event attendance. As shown, the computer system 100 includes a database 110, a server 120, and client computing devices 130.1-2. The database 110, server 120, and client computing devices 130 may be configured to communicate with one another via a network 140. The network 140 may include the Internet, an intranet, a local area network, a wide area network, a wired network, a wireless network, or a virtual private network (VPN).

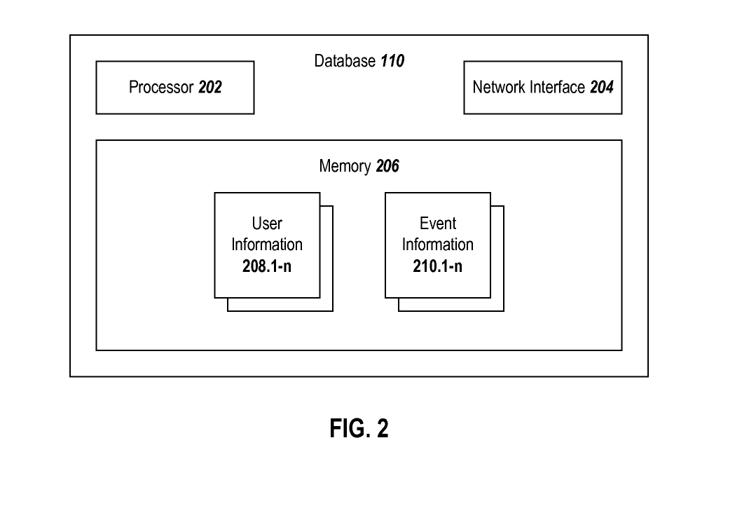

The database 110 may store data (e.g., text, images, videos, audio files, etc.) related to users (e.g., members of a social network, invited guests to an event, etc.) and information related to events (e.g., host, location, event type/description, etc.). The database 110 is described in more detail in conjunction with FIG. 2, below.

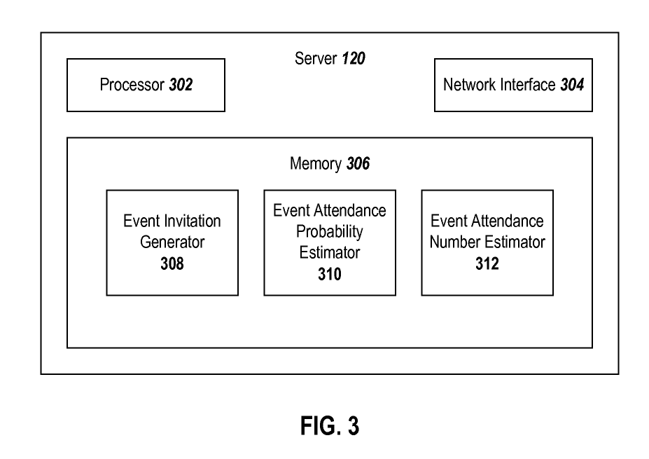

The server 120 may store data and instructions related to determining invitations for events, estimating a probability of a specific user attending an event, and estimating a number of users attending event. The server may be implemented as a single processor machine, as a multiprocessor machine, or as a server farm including multiple machines. The server 120 is described in more detail in conjunction with FIG. 3, below.

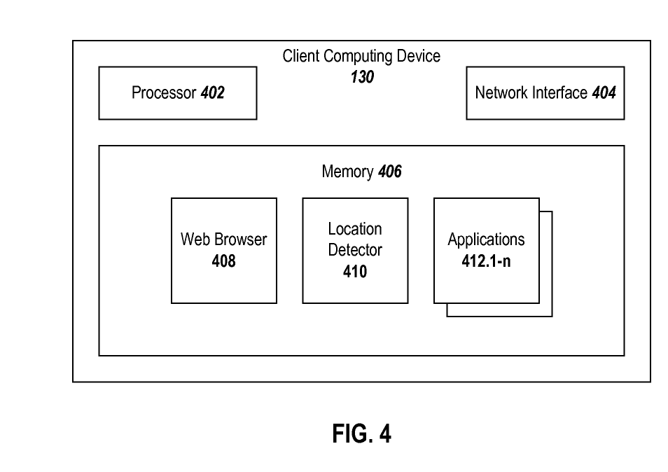

The client computing device 130 may be a laptop computer (e.g., client computing device 130.1), a desktop computer, a mobile phone (e.g., client computing device 130.2), a personal digital assistant (PDA), a tablet computer, a netbook, a television with one or more processors embedded therein or coupled thereto, a physical machine, or a virtual machine. The client computing device 130 may include one or more of a keyboard, a mouse, a display, or a touch screen. The client computing device 130 may also include a web browser configured to display webpages or search webpages. While only two client computing devices 130 are illustrated in FIG. 1, the subject technology may be implemented in conjunction with any number of client computing devices 130 (e.g., one client computing device, two client computing devices, or more than two client computing devices). One example of the client computing device 130 is described in more detail in conjunction with FIG. 4 below.

FIG. 2 illustrates an example of the database 110 in more detail.

As shown, the database 110 includes a processor 202, a network interface 204, and a memory 206. The processor 202 is configured to execute computer instructions that are stored in a computer-readable medium, for example, the memory 206. The processor 202 may be a central processing unit (CPU). While only one processor 202 is illustrated, the database 110 may include multiple processors. The network interface 204 is configured to allow the database 110 to transmit and receive data in a network, e.g., network 140 of FIG. 1. The network interface 204 may include one or more network interface cards (NICs). The memory 206 may store data or instructions. As illustrated, the memory 206 includes user information 208.1-n and event information 210.1-n.

The user information 208.1-n may be associated with a user. The user may be any user of the event planning service, and may be identified by a name, an electronic messaging address, a telephone number, a username, or any other user identifier.

The user information 208.1-n may include information about a user of an event planning service who was invited to an event (e.g., a social event) or who responded to the invitation to the event (e.g., by entering a response or an RSVP to the event). The user information may include an RSVP by the user to the event or a response by the user to the invitation to the event. The response may be, for example, (1) selected from the set: “yes,” “maybe,” and “no,” (2) selected from the set: “attending,” “maybe attending,” and “not attending,” (3) selected from the set: “join,” “maybe,” and “decline,” (4) selected from the set “attending,” and “not attending,” or (5) selected from the set “yes,” and “no.” Alternatively, the user information 208.1-n may include an indication that the user did not respond to the event invitation.

The user information 208.1-n may include an event attendance history of the user. The event attendance history may include past events to which the user was invited, past responses or lack of responses of the user to the event invitations, and information regarding whether the user attended or appeared at the event. Information regarding whether the user attended or appeared at the event may be determined, for example, based on a host of the event taking attendance at the event, or based on the user entering a geographic check-in at the event, e.g., via a mobile phone. The event attendance history of the user may be relevant to determine a relationship between the user's responses or lack of responses to event invitations and whether the user attends the event.

The user information 208.1-n may also include a default location of the user (e.g., a home location, a home city, a work location, or a work city), a set of social networking contacts of the user, a set of close friends of the user, a willingness to travel of the user, a business type of the user, or a personal viewpoint (e.g., a religious viewpoint) of the user. The user information 208.1-n may include an indication whether the default location of the user has changed since the indication of the response by the user to the event invitation was received. The set of close friends of the user may be determined based on, for example, the user's social graph. The set of close friends may be a subset of the set of social networking contacts. Alternatively, the set of close friends may include at least one entity who is not a member of the set of social networking contacts. The willingness to travel of the user may be determined based on a distance between a plurality of check-ins entered by the user and the default location of the user. For example, a user who has multiple check-ins within 100-200 km of his/her default location may have a greater willingness to travel than a user who has very few check-ins more than 25 km from his/her default location. The business type of the user (e.g., legal, engineering, finance, education, etc.) and/or the personal viewpoint of the user may be provided as input by the user, for example, when registering for a social networking service or an event planning service.

The user information 208.1-n may also include an indication whether the default location of the user has changed since the indication of the response by the user to the event invitation was received. The indication whether the default location of the user has changed may be relevant because if a user moves between the time when he/she RSVPs to the event and the time of the event, the user may be more or less likely to attend the event, based on whether the user moved closer to or further from the event.

The user information 208.1-n may also include an indication whether the user indicated that he/she would attend a different event simultaneous with the event to which the user received the invitation. Such an indication may be useful in determining whether the user will attend the event to which the user received the invitation because the user cannot attend two events simultaneously. For example, if the user is 80% likely to attend a different event at the same time as the event to which the user received the invitation, the probability that the user will attend the latter event may be less than or equal to 20%. In some examples, the server 120 may not include one or more of the above-described user information 208.1-n items or the server 120 may include other user information 208.1-n items not listed above.

The event information 210.1-n may be associated with an event. The event information 210.1-n may be separate and distinct from the user information 208.1-n. The event information 210.1-n may include, for example, a title of the event, a date and time of the event, a location of the event, a host of the event, or an event type of the event. Example event types include a family event (e.g., a family Christmas party), a social event (e.g., a birthday party for a member of a group of friends), a business event (e.g., an office holiday party), or a religious event (e.g., a religious service for a religious holiday). The event information may also include one or more other guests who were invited to the event, whether the one or more other guests responded to the invitations, how the one or more other guests responded, and a likelihood of attendance of the one or more other guests.

The event information 210.1-n may include an indication whether a location of an event, a date of the event, or a time of the event was changed since a response by the user to the invitation was received. Such information may be useful in predicting the attendance of the user at the event, for example, as the user might change his/her attendance decision based on the changed time or location but fail to update his/her response to the invitation. For example, if an event changes its date and time from a Saturday evening to a Monday morning, the user may be more or less likely to attend the event. Similarly, if an event changes its location (e.g., from a location a few blocks from the user's home to a 30 km away from the user's home) the user may be more or less likely to attend the event. In some examples, the server 120 may not include one or more of the above-described event information 210.1-n items or the server 120 may include other event information 210.1-n items not listed above.

In some implementations, a distance between the default location (e.g., home location or work location) of the user or the location of the event may be determined based on the user information 208.1-n and/or the event information 210.1-n. The estimated probability of the user attending the event may be determined based on the distance. For example, a user may be more likely to attend an event close to his/her default location than an event far from his/her default location.

In some implementations, a relationship between the user and the host of the event, or between the user and one or more other guests at the event may be determined based on the user information 208.1-n and/or the event information 210.1-n. The estimated probability of the user attending the event may be determined based on the relationship. For example, a user may be more likely to attend an event if his/her significant other is the host, or a user may be less likely to attend an event if his/her mother in law is likely to attend the event.

FIG. 3 illustrates an example of the server 120 in more detail.

As shown, the server 120 includes a processor 302, a network interface 304, and a memory 306. The processor 302 is configured to execute computer instructions that are stored in a computer-readable medium, for example, the memory 306. The processor 302 may be a central processing unit (CPU). While only one processor 302 is illustrated, the server 120 may include multiple processors. Furthermore, while the server 120 is illustrated as a single machine, the server 120 may include multiple machines, e.g., within a server farm. The network interface 304 is configured to allow the server 120 to transmit and receive data in a network, e.g., network 140 of FIG. 1. The network interface 304 may include one or more network interface cards (NICs). The memory 306 may store data or instructions. As illustrated, the memory 306 includes an event invitation generator 308, an event attendance probability estimator 310, and an event attendance number estimator 312.

The event invitation generator 308 may be configured to receive input from an organizing user (e.g., a host or an organizer of the event) describing the event, to receive a guest list for the event, and to provide invitations to the event for one or more members of the guest list. The event invitations may be transmitted (e.g., to the members of the guest list via electronic messages. The members of the guest list may include users (e.g., users of an event invitation service, users of a social network, users of email, users of one or more computing devices, etc.) The electronic messages may be email messages, mobile phone text or picture messages, and/or messages transmitted via a social network. The electronic messages may include a link for viewing a webpage including more information about the event or a link or a button to respond to the event invitation (e.g., to RSVP to the event).

The event attendance probability estimator 310 is configured to predict the probability that a user to whom an event invitation was transmitted will attend the event. The event attendance probability estimator 310 may include code for receiving user information (e.g., user information 208.k) related to the user and event information (e.g., event information 210.k) related to the event. The event attendance probability estimator 310 may also include code for determining an estimated probability of the user attending the event based on the user information and/or the event information. The event attendance probability estimator 310 may also include code for providing an indication of the estimated probability. For example, the estimated probability may be displayed on a page associated with the event as a percentage (e.g., 75% likely to attend.)

The event attendance number estimator 312 is configured to predict a number of guests that will attend an event. The number of guests may include only guests who have been invited to the event. Alternatively, the number of guests may include guests who have been invited to the event and additional guests. The additional guests may have been invited by non-electronic means (e.g., by word of mouth), by communications not associated with an event planning service or social network through which the event was planned, or by guests to the event inviting additional guests. For example, the event planning service may be associated with a social network. An event planner may invite a first user to the event via the social network. Upon receiving the event invitation, the first user may invite a friend to the event by email, where the friend is not a member of the social network. Both the first user and the friend may be taken into account in determining the predicted number of guests that will attend the event.

The event attendance number estimator 312 may include code for facilitating transmitting an invitation to each user within a set of users, where the invitation identifies an event. The event attendance number estimator may also include code for receiving a user information subset (e.g. user information 208.1-n) related to each user within a subset of the set of users (e.g., a subset of users for whom user information is available). The event attendance number estimator 312 may also include code for receiving event information (e.g., event information 210.k) related to the event. The event attendance number estimator 312 may include code for determining an estimated number of guests attending the event based on the user information subset and/or the event information. The estimated number of guests may include both users within the set of users and additional guests who are not users within the set of users (e.g., guests who were invited via a source other than the server 120). The event attendance number estimator 312 may provide an indication of the estimated number of guests. For example, the estimated number of guests may be displayed on a page associated with the event (e.g., “Expected attendance: 4.”).

FIG. 4 illustrates an example of the client computing device 130 in more detail.

As shown, the client computing device 130 includes a processor 402, a network interface 404, and a memory 406. The processor 402 is configured to execute computer instructions that are stored in a computer-readable medium, for example, the memory 406. The processor 402 may be a central processing unit (CPU). The network interface 404 is configured to allow the client computing device 130 to transmit and receive data in a network, e.g., network 140 of FIG. 1. The network interface 404 may include one or more network interface cards (NICs). The memory 406 may store data or instructions. As illustrated, the memory 406 includes a web browser 408, a location detector 410, and applications 412.1-n.

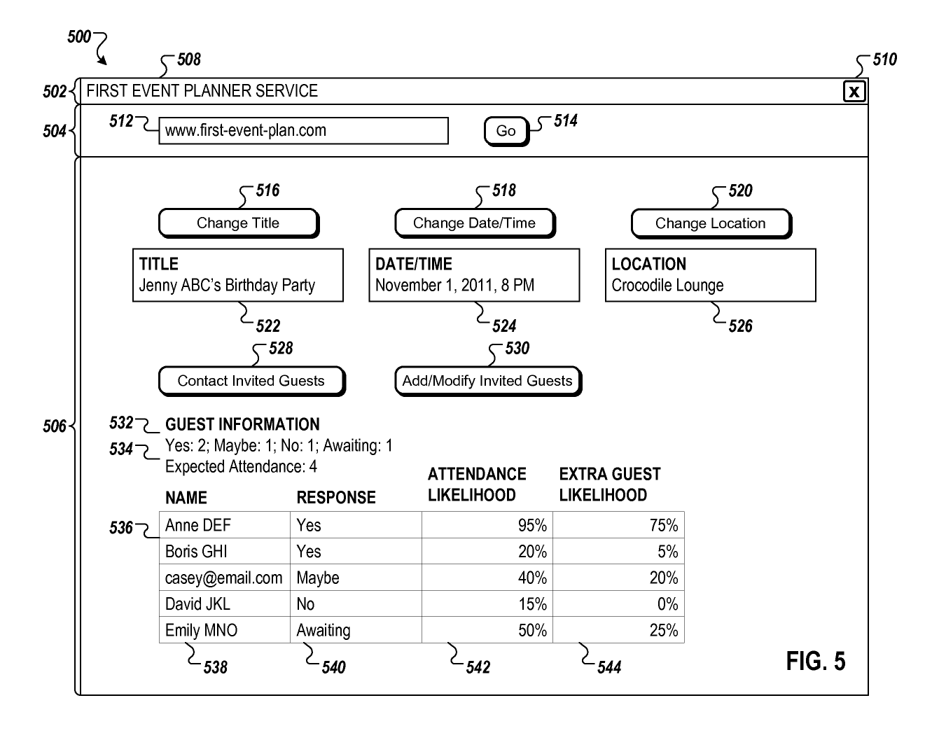

The web browser 408 may be configured to display webpages via a display. An example of a web browser (e.g., web browser 408) displaying a webpage in a display is provided in FIG. 5 and described in detail below. The web browser 408 may be configured to access a webpage associated with an event planning service and/or a webpage associated with a social network. The web browser 408 may be one of the applications 412.1-n.

The location detector 410 may be configured to detect a location of the client computing device 130. The location detected by the location detector 410 may be based on one or more of a global positioning system (GPS) signal, a wireless access point accessible to the client computing device 130, or a cellular signal. The client computing device 130 may use the location detected by the location detector, for example, to enter a geographic check-in, to add a geographic tag to a photograph taken by the client computing device 130, to record a current location of the client computing device 130, or for any other purpose.

The applications 412.1-n may include any applications configured to execute, at least in part, on the client computing device 130. The applications 412.1-n may include one or more of a social networking application, an event planning application, a geographic check-in application, a photograph taking application, or a word processing application. Other applications may also be included in applications 412.1-n.

FIG. 5 illustrates an example of a web browser window 500 configured to display information about an event.

The web browser window 500 may be displayed via a display of a client computing device (e.g., client computing device 130) via the operation of a web browser (e.g., web browser 408). As shown, the web browser window 500 includes a header region 502, a control region 504, and a webpage display region 506.

The header region 502 may include a title 508 and a close button 510. The title 508 may include a title of a webpage being displayed in the webpage display region 506, e.g. “First Event Planner Service.” The close button 510, when selected, may be configured to cause the web browser window 500 to close.

The control region 504 includes a uniform resource locator (URL) input box and a go button 514. The URL input box 512 is configured to receive an input of a URL entered by an end-user of the web browser window 500 and to cause the webpage display region 506 of the web browser window 500 to display a webpage associated with the entered URL in response to the user clicking enter or return while typing in the URL input box 512. The go button 514, when selected, is configured to cause a webpage associated with a URL in the URL input box 512 to be displayed in the webpage display region 506 of the web browser window 500.

The webpage display region 506 is configured to display a webpage. As illustrated, the webpage display region 506 displays a webpage associated with an event planning service. As shown, the webpage display region 506 includes a change title button 516, a change date/time button 518, a change location button 520, an event title 522, an event date/time 524, an event location 526, a contact invited guests button 528, an add/modify invited guests button 530, and a guest information section 532.

The event title 522 displays a stored title of an event about which information is being presented, for example, “Jenny ABC's Birthday Party.” When clicked, the change title button 516, may allow a user of the web browser window to change the stored title of the event.

The event date/time 524 displays a stored date and a time of the event, for example, “Nov. 1, 2011, 8 PM.” When clicked, the change date/time button 518 may allow a user of the web browser window to change the stored date/time of the event.

The event location 526 displays a stored location of the event, for example, “Crocodile Lounge.” When clicked, the change location button 520 may allow a user of the web browser window to change the stored location of the event.

The stored event title, stored date and time of the event, and/or the stored location of the event may be stored on the server or in a database (e.g., in event information 210.k). In one example, only a first set of users may be able to view the event information about a particular event (e.g., the information presented in the webpage display region 506), and only a subset of the first set of users (e.g., users who are organizers of the event) may be able to modify the event information (e.g., the event title 522, the event date/time 524, and the event location 526) of the particular event. The change title 516, change date/time 518, and change location 520 buttons may be presented to members of the subset of the first set of users, while not being presented to other users.

The contact invited guests button 528, when clicked, may be configured to allow a user of the web browser window 500 to contact the invited guests, for example, by an electronic message transmitted to an email address or a mobile phone, by an instant text, audio, or video message, or by voicemail. An invited guest may specify controls for communication, e.g., the modes of communication by which the invited guest may be contact. For example, an invited guest may specify that he/she may be contacted via electronic messages to an email address but not via voice messages or electronic messages to a mobile phone. In some example, members of the subset of the first set of users may be able to contact the invited guests and the contact invited guests button 528 may be presented to members of the subset of the first set of users, while not being presented to other users.

The add/modify invited guests button 530, when selected, may allow a user of the web browser window 500 to add or modify the list of invited guests. In some example, members of the subset of the first set of users may be able to add or modify the invited guests and the add/modify invited guests button 530 may be presented to members of the subset of the first set of users, while not being presented to other users.

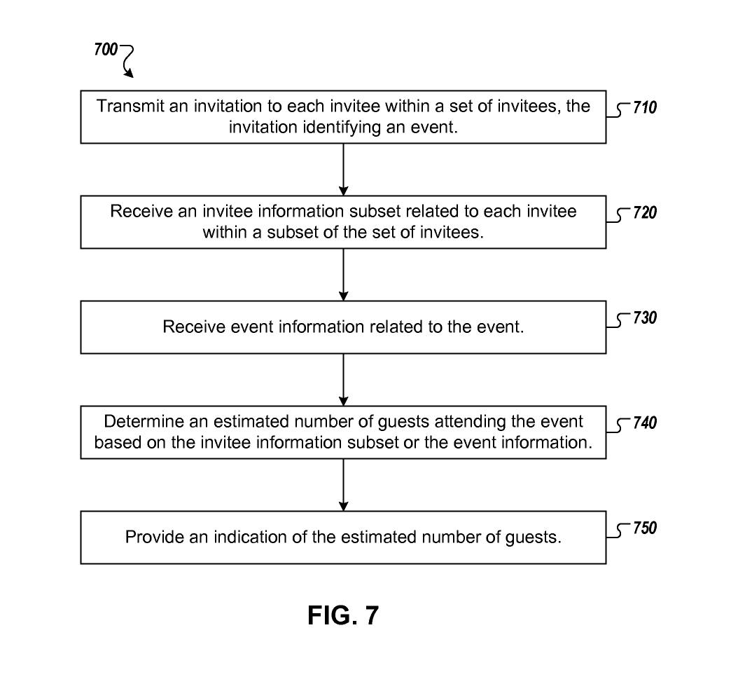

As shown, the guest information 532 includes a summary section 534 and a guest table 536. The summary section 534 is configured to display a number of invited guests whose responses are awaited and a number of guests who entered each response-type (e.g., “yes,” “maybe,” or “no”) in response to their invitations. As shown, two guests entered a “yes” response, one guest entered a “maybe” response, one guest entered a “no” response, and one guest's response is awaited. The summary section may also be configured to display an expected attendance number (e.g., four). The expected attendance number may be determined, for example, by the operation of the event attendance number estimator 312 or by the process described below in conjunction with FIG. 7.

As illustrated, the guest table 536 includes a name column 538, a response column 540, an attendance likelihood column 542, and an extra guest likelihood column 544.

The name column 538 lists the names of the invited guests (e.g., “Anne DEF”). In some cases, a name of a guest may be unknown, and another identifier, for example, an email address (e.g., “casey@email.com”) may be displayed in place of the name. An invited guest (e.g., “Anne DEF”) can specify limitations for information displayed in the guest table 536 or in any other location of the webpage displayed in the webpage display region 506. In one implementation, an invited guest may limit having his/her information displayed in the guest table 536 before his/her information is displayed in the guest table 536.

The response column 540 lists the responses to the event invitation entered by the invited guests identified in the name column. As illustrated, the responses include “yes,” “maybe,” and “no.” In some cases, if a response has not been entered by an invited guest, an “awaiting” indicator may be displayed in the response column in the row of the name of the invited guest.

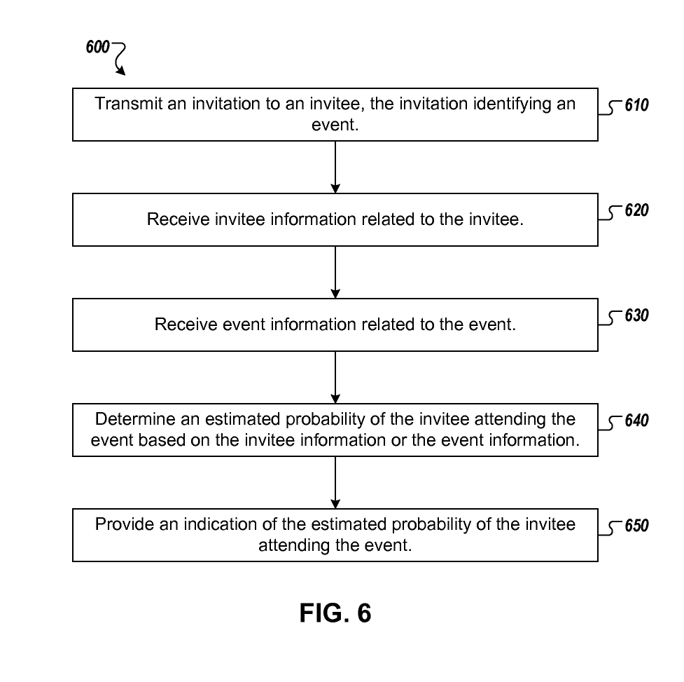

The attendance likelihood 542 indicates the likelihood that an invited guest whose name is listed in the name column 538 will attend the event. The attendance likelihood may be determined based on the event information (e.g., event information 210.k) and the user information (e.g., user information 208.k) of the invited guest. The user information may include the response of the invited guest in the response column 540. In one example, the attendance likelihood may be determined by the operation of the event attendance probability estimator 310 or by the process described below in conjunction with FIG. 6.

The extra guest likelihood 544 indicates a likelihood that an invited guest named in the invited guest column 538 will bring an extra guest with him/herself to the event. For example, an event organizer at a corporation may invite an employee of the corporation to a mid-summer party via an online event planning service. The employee may verbally invite his/her significant other to the mid-summer party. The probability of the significant other attending the mid-summer party may be represented in the extra guest likelihood column 544.

In one example, the extra guest likelihood may be calculated by multiplying an attendance likelihood of an invited guest by an extra guest probability for the invited guest. The extra guest probability for the invited guest may be determined based on information about how often the invited guest brought an extra guest to events in the past. The information about how often the invited guest brought an extra guest to events in the past may be stored with other information about the invited guest (e.g., in user information 208.k associated with the invited guest).

FIG. 6 illustrates an example process 600 by which an estimated probability of an invitee attending an event may be provided.

The process 600 begins at step 610, where the server (e.g., server 120) transmits an invitation to an invitee. The invitation may identify an event. The invitee may be a member or user of a social network, a user of an email account, and/or a user of a mobile phone messaging account. The server may transmit the invitation to the invitee via one or more of an electronic message to an email address, an electronic message to a mobile phone, or an electronic message transmitted within a social network.

In step 620, the server receives invitee information related to the invitee. The invitee information may include the response of the invitee to the invitation (e.g., accept, decline, or maybe) or an indication that the invitee did or did not view the invitation or did or did not respond to the invitation. The invitee information may also include a history of events to which the invitee was invited, the invitee's responses to the invitations to the events in the history, and whether the invitee actually attended the events. The invitee may be a member of a social network, and the invitee information may also include a social networking profile of the invitee, which may include, for example, a default location (e.g., a home or work location) of the invitee, an age of the invitee, a gender of the invitee, a set of social contacts of the invitee, etc. The invitee information may also include one or more other events to which the invitee was invited and an indication of the invitee's response(s) to the invitation(s). The other events may occur simultaneously with, before, or after the event to which the invitation was transmitted in step 610.

In step 630, the server receives event information related to the event. The event information may include an event title, an event date and time, and/or an event location. The event information may also identify a host of the event or the event type. The event type may include one or more of a family event (e.g., a baby shower for members of a family), a social event (e.g., an outing with a group of friends), or a business event (e.g., a networking event for members of a professional organization). The event information may also include information about whether the event title, the event date and time, or the event location were changed since the event was created or since the invitation was transmitted in step 610. The event information may also include information about one or more other invitees who were invited to the event and how the other invitees responded to the invitation(s).

In step 640, the server determines an estimated probability of the invitee attending the event based on the invitee information and/or the event information. The estimated probability may be based on one or more of the data within the invitee information and the event information, as listed above.

In step 650, the server provides an indication of the estimated probability of the invitee attending the event. The indication of the estimated probability may be displayed on a webpage associated with the event. (See, e.g., attendance likelihood 542 of FIG. 5.) The webpage may be within a social network. Alternatively, the estimated probability may be transmitted via an electronic message to the invitee and/or to a host, organizer, or planner of the event. After step 650, the process 600 ends.

FIG. 7 illustrates an example process 700 by which an estimated number of guests attending an event may be provided.

The process 700 begins at step 710, where the server (e.g., server 120) transmits an invitation to each invitee within a set of invitees. The invitation may identify an event. As set forth above, the server may transmit each invitation as an electronic message via a social network, to an email address, or to a mobile phone.

In step 720, the server receives an invitee information subset related to each invitee within a subset of the set of invitees. The invitee information subset may include the invitee information described above. Some invitees (e.g., invitees in the set of invites but not in the subset of invitees) may not have any invitee information available or accessible to the server or may decline to provide their invitee information to the server for the purpose of predicting attendance at the event.

In step 730, the server receives event information related to the event. The event information may include any event information described above.

In step 740, the server determines an estimated number of guests attending the event based on the invitee information subset and/or the event information. The guests attending the event may include both invitees in the set of invitees and other guests, who may not be invitees within the set of invitees. The guests who are not invitees within the set of invitees may attend the event without an invitation or may have been invited to the event verbally, via a paper invitation, or via an electronic invitation not transmitted via the server.

The estimated number of guests attending the event may be based on an estimated probability of at least one invitee within the subset of the set of invitees attending the event. In one implementation, the estimated number of guests attending the event may be based on a sum of an estimated number of invitees within the set of invitees attending the event and an estimated number of guests who are not invitees within the set of invitees attending the event.

The estimated number of invitees attending the event may be calculated as the sum of the estimated probability of each invitee attending the event, where the estimated probability is expressed as a value between 0 and 1. For example, if four invitees each have an estimated probability of attending the event of 0.5, the estimated number of invitees attending the event may be 0.5+0.5+0.5+0.5=2.

Furthermore, a guest who is not an invitee may attend the event because the guest came to the event without an electronic invitation. For example, a host may organize a birthday party via the server and invite his/her friend using an electronic invitation generated by the server. The friend may respond affirmatively to the invitation and bring an additional guest (e.g., his/her spouse) without specifying the guest on the electronic invitation. Both the friend and the spouse or other additional guest may attend the birthday party.

In one implementation, in the above example, the probability of the spouse attending the birthday party may be a conditional probability based on the friend attending the birthday party. For example, the friend may have a 60% probability of attending the birthday party. The spouse may have a 80% probability of attending the event if the friend attends or a 10% probability of attending the event if the friend does not attend. In this case, the total probability of the spouse attending may be calculated according to equation (1) below:

P(spouse attends)=P(friend attends)*P(spouse attends|friend attends)+P(! friend attends)*P(spouse attends|! friend attends) (1)

In equation (1), P(x) indicates the probability of event x, the bar (|) indicates “given that,” and the exclamation point (!) indicates “not.” Based on the example numbers set forth above, P(spouse attends)=0.6*0.8+(1−0.6)*0.1=0.52. It should be noted that “friend” and “spouse” are one example of an invitee and an additional guest invited by an invitee. In other examples, the invitee may be someone other than a friend, e.g., a spouse, a colleague, an acquaintance, a business associate, a coworker, a family member, etc., and the additional guest may be someone other than the invitee's spouse, e.g., the invitee's friend, colleague, acquaintance, business associate, coworker, family member, etc. In some circumstances, an invitee may invite more than one additional guest, each of whom may have a probability of attending the event. For example, an invitee who receives an invitation to an event via the server may orally invite two of his/her friends who were not invited by the server to the event.

Furthermore, the estimated number of guests attending the event may be based on a number of invitees within a second subset of the set of invitees. The second subset may include invitees within the set of invitees and not within the subset of invitees for whom invitee information was received in step 720. In one implantation, the server may assign a probability of attendance value (e.g., 30%) for such invitees. The estimated number of invitees within the second subset attending the event may be the number of such invitees multiplied by the probability of attendance value. For example, if the second subset includes 20 invitees and each invitee in the second subset has a probability of attendance value of 40%, the estimated number of attending invitees from within the second subset may be 20*40%=8.

In step 750, the server provides an indication of the estimated number of guests attending the event. The indication of the estimated number of guests may be presented within a webpage associated with the event (e.g., in the summary section 534 of the guest information 532 of FIG. 5). Alternatively, the indication of the estimated number of guests may be transmitted in an electronic message to the host or organizer of the event or to one or more invitees to the event. After step 750, the process 700 ends.

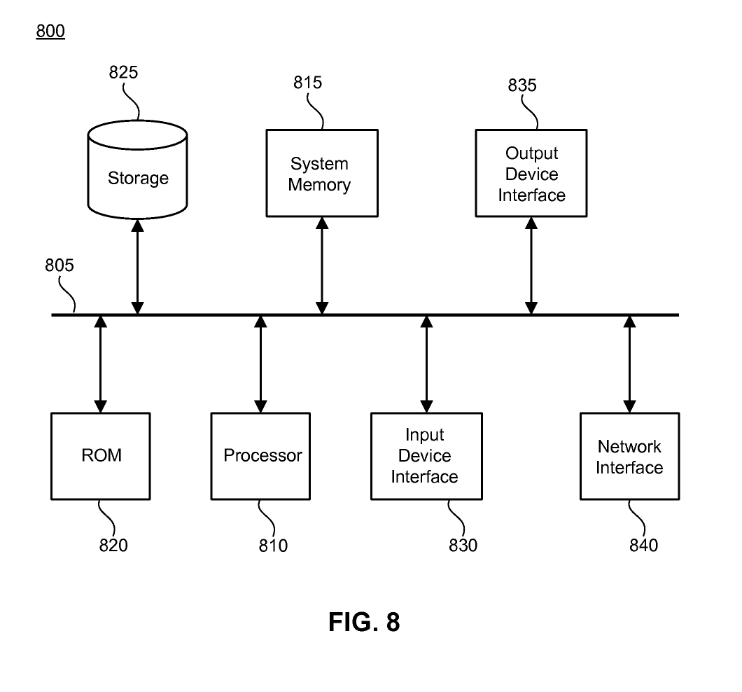

FIG. 8 conceptually illustrates an electronic system 800 with which some implementations of the subject technology are implemented. For example, one or more of the database 110, the server 120, or the client computing device 130 may be implemented using the arrangement of the electronic system 800. The electronic system 800 can be a computer (e.g., a mobile phone, PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, an input device interface 830, an output device interface 835, and a network interface 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the subject technology. The processing unit(s) can be a single processor or a multi-core processor in different implementations.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some implementations of the subject technology use a mass-storage device (for example a magnetic or optical disk and its corresponding disk drive) as the permanent storage device 825.

Other implementations use a removable storage device (for example a floppy disk, flash drive, and its corresponding disk drive) as the permanent storage device 825. Like the permanent storage device 825, the system memory 815 is a read-and-write memory device. However, unlike storage device 825, the system memory 815 is a volatile read-and-write memory, such a random access memory. The system memory 815 stores some of the instructions and data that the processor needs at runtime. In some implementations, the processes of the subject technology are stored in the system memory 815, the permanent storage device 825, or the read-only memory 820. For example, the various memory units include instructions for event attendance prediction in accordance with some implementations. From these various memory units, the processing unit(s) 810 retrieves instructions to execute and data to process in order to execute the processes of some implementations.

The bus 805 also connects to the input and output device interfaces 830 and 835. The input device interface 830 enables the user to communicate information and select commands to the electronic system. Input devices used with input device interface 830 include, for example, alphanumeric keyboards and pointing devices (also called “cursor control devices”). Output device interfaces 835 enables, for example, the display of images generated by the electronic system 800. Output devices used with output device interface 835 include, for example, printers and display devices, for example cathode ray tubes (CRT) or liquid crystal displays (LCD). Some implementations include devices for example a touchscreen that functions as both input and output devices.

Finally, as shown in FIG. 8, bus 805 also couples electronic system 800 to a network (not shown) through a network interface 840. In this manner, the electronic system 800 can be a part of a network of computers (for example a local area network (“LAN”), a wide area network (“WAN”), or an Intranet, or a network of networks, for example the Internet. Any or all components of electronic system 800 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A method, implemented on one or more computing devices, for predicting attendance at an event, the method comprising:
transmitting, via the one or more computing devices, an invitation to an invitee, the invitation identifying the event;
receiving, at the one or more computing devices, invitee information related to the invitee, wherein the invitee information comprises an indication of a past response by the invitee to an invitation to a past event and an indication of whether the invitee attended the past event;
receiving, at the one or more computing devices, event information related to the event;
determining a distance between a default location of the invitee and a location of the event based on the invitee information or the event information;
determining an estimated probability of the invitee attending the event based on a combination of the distance, the invitee information, including the indication of the past response by the invitee to the invitation to the past event and the indication of whether the invitee attended the past event, and the event information; and
providing an indication of the estimated probability of the invitee attending the event for display to a user.

2. The method of claim 1, wherein the event information is separate and distinct from the invitee information.

3. The method of claim 1, wherein the invitee information comprises a response by the invitee to the invitation.

4. The method of claim 1, wherein the invitee information comprises an indication that the invitee did not respond to the invitation.

5. The method of claim 1, wherein the invitee information comprises an event attendance history of the invitee.

6. (canceled)

7. The method of claim 1, wherein the indication of whether the invitee attended the past event comprises a geographic check-in by the invitee corresponding to a location of the past event and a time of the past event.

8. The method of claim 1, wherein the indication of whether the invitee attended the past event comprises a photograph of the invitee at the past event.

9. The method of claim 8, wherein the photograph is automatically associated with the invitee via facial recognition.

10. The method of claim 1, wherein the invitee information comprises one or more of: a default location of the invitee, a set of close friends of the invitee, a willingness to travel of the invitee, a business type of the invitee, or a personal viewpoint of the invitee.

11. The method of claim 1, wherein the invitee information comprises an indication whether the invitee indicated that the invitee would attend a different event simultaneous with the event.

12. The method of claim 1, wherein the invitee information comprises an indication whether a default location of the invitee was changed since the indication of the response by the invitee to the event invitation was received.

13. The method of claim 1, wherein the event information comprises one or more of: a location of the event, a host of the event, a date of the event, a time of the event, or an event type of the event.

14. The method of claim 13, wherein the event type comprises one or more of: a family event, a social event, a business event, or a religious event.

15. The method of claim 1, wherein the event information comprises an indication whether a location of the event, a date of the event, or a time of the event was changed since a response by the invitee to the invitation was received.

16. (canceled)

17. The method of claim 1, further comprising:
determining a relationship between a host of the event and the invitee based on the invitee information or the event information; and
determining the estimated probability based on the relationship.

18. A computer-readable medium for predicting attendance at an event, the computer-readable medium comprising instructions which, when executed by one or more computers, cause the one or more computers to:
transmit an invitation to a member of a social network, the invitation identifying the event;
receive member information related to the member, wherein the member information comprises an indication of a past response by the member to an invitation to a past event and an indication of whether the member attended the past event;
receive event information related to the event;
determining a distance between a default location of the member and a location of the event based on the member information or the event information;
determine an estimated probability of the member attending the event based on a combination of the distance, the member information, including the indication of the past response by the member to the invitation to the past event and an indication of whether the member attended the past event, and the event information; and
provide an indication of the estimated probability of the member attending the event for display to a user.

19. The computer-readable medium of claim 18, wherein the event information is separate and distinct from the member information.

20. The computer-readable medium of claim 18, wherein the member information comprises a profile of the member within the social network.

21. The computer-readable medium of claim 18, wherein the instructions to provide an indication of the estimated probability comprise instructions which, when executed by the one or more computers, cause the one or more computers to:
provide for display the indication of the estimated probability on a page associated with the event, the page being within the social network.

22. The computer-readable medium of claim 18, wherein the instructions to provide an indication of the estimated probability comprise instructions which, when executed by the one or more computers, cause the one or more computers to:
provide the indication of the estimated probability to a host of the event.

23. A system for predicting attendance at an event, the system comprising:
one or more processors; and
a memory comprising instructions which, when executed by the one or more processors, cause the one or more processors to:
transmit an invitation to each invitee within a set of invitees, the invitation identifying the event;
receive an invitee information subset related to each invitee within a first subset of the set of invitees, wherein the invitee information subset for at least one invitee from among the first subset of the set of invitees comprises an indication of a past response by the at least one invitee to an invitation to a past event and an indication of whether the at least one invitee attended the past event;
receive event information related to the event;
determining a distance between a default location of at least one invitee and a location of the event based on the invitee information subset or the event information;
determine an estimated number of guests attending the event based on a combination of the distance, the invitee information subset, including the indication of the past response by the at least one invitee to the invitation to the past event and the indication of whether the at least one invitee attended the past event, and the event information; and
provide an indication of the estimated number of guests for display to a user.

24. The system of claim 23, wherein the estimated number of guests attending the event is based on a sum of an estimated number of invitees within the set of invitees attending the event and an estimated number of guests who are not invitees within the set of invitees attending the event.

25. The system of claim 23, wherein the estimated number of guests attending the event is based on a number of invitees within a second subset of the set of invitees, wherein the second subset of the set of invitees comprises invitees within the set of invitees and not within the first subset of invitees.

26. The system of claim 23, wherein the estimated number of guests attending the event is based on an estimated probability of at least one invitee within the first subset of the set of invitees attending the event.
